(19) United States
(12) Patent Application Publication
(10) Pub. No.: US 2002/0195426 A1
(43) Pub. Date: Dec. 26, 2002

(54) Bosses and method for fastening same

(76) Inventors: Kailash C. Vasudeva, Waterloo (CA); Maz A. Hasan, Kitchener (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/176,117

(22) Filed: Jun. 21, 2002

Related U.S. Application Data
(60) Provisional application No. 60/299,433, filed on Jun. 21, 2001.

(51) Int. Cl. B23K 9/00

(52) U.S. Cl. 219/61; 219/137 R; 219/121.64

(57) ABSTRACT

A boss for attaching to a manufactured hole in a pipe has a generally cylindrical hollow body, with an external surface and an internal surface, a first end and a second end. The second end has a smaller external diameter than a diameter of the external surface. The second end aligns with the hole, and has pointed protrusions, for concentrating a weld spark during welding. The external surface is stepped forming a larger diameter portion adjacent the first end and a smaller diameter portion adjacent the second end. The smaller diameter portion has a diameter larger than the diameter of the second end. Alternatively, the second end has a bevelled portion cooperating with a pointed end of the hole, or a skirt generally conforming to the profile of the pipe, the skirt having pointed protrusions, for concentrating a weld spark during welding.

### BACKGROUND OF THE INVENTION

This invention relates mainly to bosses, and especially bosses fastened to exhaust pipes for mounting, for example, exhaust monitoring equipment. A typical known boss is shown in FIGS. 24 and 25. The boss 100 is generally cylindrical having a central hole 110, preferably threaded. The boss has an outer cylindrical surface 120 and a first substantially flat surface and a second substantially flat surface 130. Either of the first or second surfaces are welded to a surface of a pipe, to form a sensor attachment for a sensor reaching into the pipe. Traditionally, the bosses have been welded onto the pipes using standard techniques (GMAW etc.), necessitating a circumferential weld around the boss following a wavering saddle-shaped line.

Traditional welding requires the material thickness of the bosses to be of a certain minimum value, to withstand the welding temperature required for a good weld. Cycle times (time from starting one weld on a first boss until starting the same weld on the next boss) are relatively long, and the weld heat may cause slag forming and/or porosity in the heat affected area of the weld. The parts may also deform because the heat will release built-in tensions of the material, or create tension when the material cools. Traditional welding methods also require the use of welding electrodes or brazing rods etc., which add to the overall cost and may cause handling and storage problems (especially for coated electrodes). The electrodes/brazing rods must, furthermore, be of a material which is compatible with both the boss material and the pipe material. A further possible problem is the risk of molten material from the weld spattering onto other parts of the welded pieces, especially the threads inside the bosses. This will necessitate a thread cleaning operation after the completion of the weld, adding to the manufacturing costs and the time required to reach a finished product.

### SUMMARY OF THE INVENTION

It is an object of the invention to improve on the existing boss attachment methods and provide a boss which facilitates the fastening of the boss to pipes of different sizes.

In the invention, a boss for attaching to a manufactured hole in a pipe has a generally cylindrical hollow body, with an external surface and an internal surface, a first end and a second end, the second end having a smaller external diameter than a diameter of the external surface, the second end cooperating with the hole, wherein the second end has pointed protrusions, for concentrating a weld spark during welding.

The external surface is advantageously stepped forming a larger diameter portion adjacent the first end and a smaller diameter portion adjacent the second end, the smaller diameter portion having a diameter larger than the diameter of the second end.

A further embodiment of a boss has a generally cylindrical hollow body, with an external surface and an internal surface, a first end and a second end, the second end having a smaller external diameter than a diameter of the external surface, the second end cooperating with the hole, wherein the second end has a bevelled portion cooperating with a pointed end of the hole, for concentrating a weld spark during welding.

Still a further embodiment of a boss has a generally cylindrical hollow body, with an external surface and an internal surface, a first end and a second end, the second end having a smaller external diameter than a diameter of the external surface, the second end cooperating with the hole, wherein the external surface has a skirt generally conforming to the profile of the pipe, the skirt having pointed protrusions, for concentrating a weld spark during welding.

Further features will be described or will become apparent in the course of the detailed description which follows.

### BRIEF DESCRIPTION OF THE DRAWINGS

The invention will now be described in greater detail, with reference to the accompanying drawings of the preferred embodiment, in which:

FIG. 1 is a sectioned side view of a first embodiment of a boss according to the invention;

FIG. 2 is a bottom view of the first embodiment of a boss shown in FIG. 1;

FIG. 3 is a sectioned end view of the first embodiment of a boss shown in FIG. 1, showing the boss inserted in a hole cut in a pipe;

FIG. 4 is a sectioned side view of a second embodiment of a boss according to the invention;

FIG. 5 is a bottom view of the second embodiment of a boss shown in FIG. 4;

FIG. 6 is a sectioned end view of the second embodiment of a boss shown in FIG. 4, showing the boss inserted in a hole cut in a pipe;

FIG. 7 is a sectioned detail view of the second embodiment of a boss shown in FIG. 6, showing the contact area between the boss and the hole in the pipe;

FIG. 8 is a sectioned end view of a third embodiment of a boss according to the invention;

FIG. 9 is a bottom view of the third embodiment of a boss shown in FIG. 8;

FIG. 10 an end view of the third embodiment of a boss shown in FIG. 8;

FIG. 11 is a top view of the third embodiment of a boss shown in FIG. 8;

FIG. 12 is a sectioned side view of a fourth embodiment of a boss according to the invention;

FIG. 13 is a top view of the fourth embodiment of a boss shown in FIG. 12;

FIG. 14 is a sectioned end view of the fourth embodiment of a boss shown in FIG. 12, showing the boss inserted in a hole cut in a pipe;

FIG. 15 is a sectioned side view of the first embodiment of a boss according to the invention, showing the boss inserted into a coined hole on a pipe;

FIG. 16 is a top view of the first embodiment of a boss shown in FIG. 15;

FIG. 17 is a sectioned end view of the first embodiment of a boss shown in FIG. 15;

FIG. 18 is a sectioned side view of the third embodiment of a boss according to the invention, showing the boss inserted into a coined hole on a pipe;

FIG. 19 is a top view of the third embodiment of a boss shown in FIG. 18;

FIG. 20 is a sectioned end view of the third embodiment of a boss shown in FIG. 18;

FIG. 21 is a sectioned side view of the first embodiment of a boss according to the invention, showing the boss inserted into a pulled-out hole on a pipe;

FIG. 22 is a top view of the first embodiment of a boss shown in FIG. 21;

FIG. 23 is a sectioned end view of the first embodiment of a boss shown in FIG. 21;

FIG. 24 is a sectioned side view of a boss according to prior art;

FIG. 25 is a top view of the prior art boss shown in FIG. 24;

FIG. 26 is a side view of a fifth embodiment of a boss according to the invention;

FIG. 27 is a sectioned side view of the fifth embodiment of a boss shown in FIG. 26;

FIG. 28 is a top view of the fifth embodiment of a boss shown in FIG. 26;

FIG. 29 is an end view of the fifth embodiment of a boss shown in FIG. 26, showing the boss inserted in a hole cut in a pipe;

FIG. 30 is a sectioned side view of the fifth embodiment of a boss shown in FIG. 29; and

FIG. 31 is a sectioned end view of the fifth embodiment of a boss shown in FIG. 29.

### DETAILED DESCRIPTION

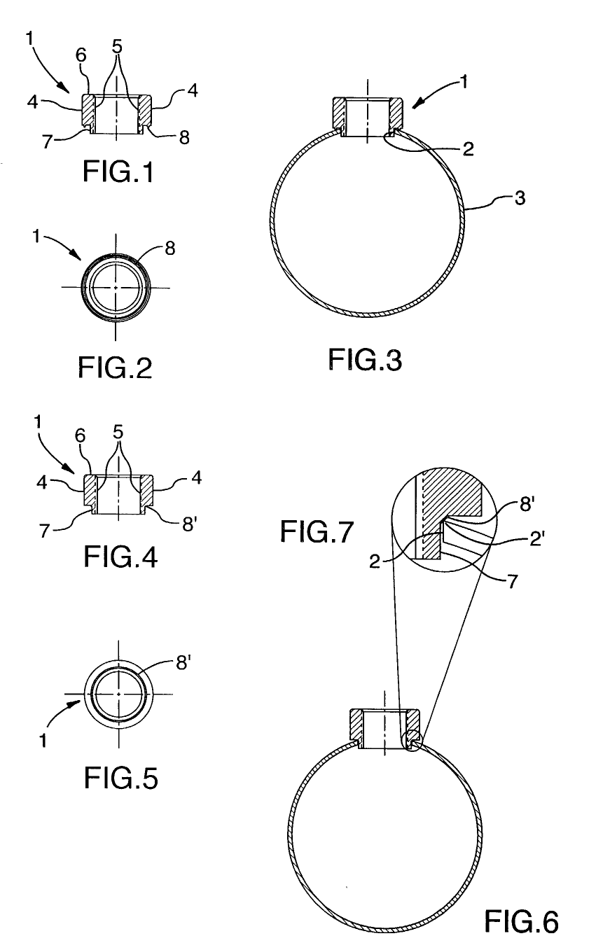

FIGS. 1 to 3 show a first embodiment of a boss 1 according to the invention. The boss is for instance attach to a manufactured hole 2 in a pipe 3, for instance an exhaust pipe. The boss has a generally cylindrical hollow body, with an external surface 4 and an internal surface 5. Further, the boss 1 has a first end 6 and an opposite second end 7, the second end having a smaller external diameter than a diameter of the external surface 4. The boss is inserted into the hole so that the second end cooperates with the hole. The second end has a pointed annular protrusion 8, for concentrating a weld spark during welding. The welding methods used are preferably laser welding, projection/resistance welding, stud/butt welding, magnetically impelled arc/butt welding (MIAB), flash welding, orbital MIG welding or percussion welding.

The boss shape is thus optimized for facilitated welding and only localized heating from the welding operation, the heat being generated substantially only around the pointed annular protrusion 8. The boss can be made with thinner walls because of the lower heat generation, which reduces the manufacturing costs. The boss could even be used with conventional arc welding equipment, and would then reduce the cycle times because of the smaller diameter of the boss (shorter weld which is made faster than a longer weld). The preferred manufacturing method for the boss is powder metallurgical methods, which makes it possible to chose the metallurgical properties of the boss to include, for instance, flux-impregnation to facilitate the welding. The boss profile can also be adapted easily to correspond to the profile of the part the boss is being welded to, for instance a saddle-shape to fit over a hole in a pipe etc. A cut and/or wrought boss is much more expensive to shape into a similar piece.

The pipe 3 and its hole 2 may advantageously be modified in shape to comply as closely as possible with the shape of the boss 1 to be welded onto the pipe. Several ways of doing this are envisioned or used, but the preferable methods are:

Punching an oval hole in the pipe using an expandable collet/jaws to pull up the sides of the hole to form a substantially flat surface adjacent and around the hole, with a uniform gap around the perimeter (ideally about 0.010″).

Coining the hole area downwards (into the pipe) during punching of the hole to create a substantially flat surface adjacent and around the hole.

Relocate the boss closer towards an end of the pipe, to accept a support mechanism used during punching/welding.

Some welding processes, for example arc welding, require the use of an opposing electrode beneath the boss inside the pipe. If the punched hole is close to the end of the pipe, a combination support mechanism/electrode (not shown) can easily be introduced in the pipe. When the hole is located further downstream, i.e. away from the end of the pipe, it becomes increasingly difficult to support the boss with a traditional cantilever support system. In these cases, an expandable mandrel/collet is introduced into the pipe through the boss after it is placed on the punched hole. After the boss is seated, the fingers of the mandrel/collet are made to expand inside the pipe below the boss. They can then act as a locating guide for the boss as well as provide support during welding. Upon completion of the welding cycle, the fingers are retracted, and the mandrel/collet removed.

FIGS. 4 to 7 show a boss 1 according to a second embodiment of the invention. The features which are the same as described earlier with regard to the first embodiment retain their reference numbers. The second end 7 has a bevelled portion 8′ cooperating with a sharp annular end 2′ of the hole 2, for concentrating a weld spark during welding. The sharp annular end of the hole is formed when punching the hole in the pipe.

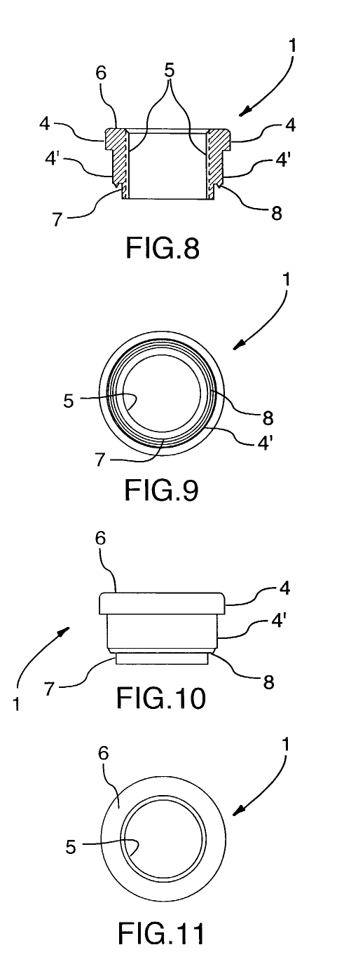

FIGS. 8 to 11 show a boss 1 according to a third embodiment of the invention. The features which are the same as described earlier with regard to the first embodiment retain their reference numbers. The external surface is stepped forming a larger diameter portion 4 adjacent the first end 6 and a smaller diameter portion 4′ adjacent the second end 7, the smaller diameter portion having a diameter larger than the diameter of the second end. This results in a reduced wall thickness of the boss, without negatively influencing the welding operation. The boss is thus cheaper to produce.

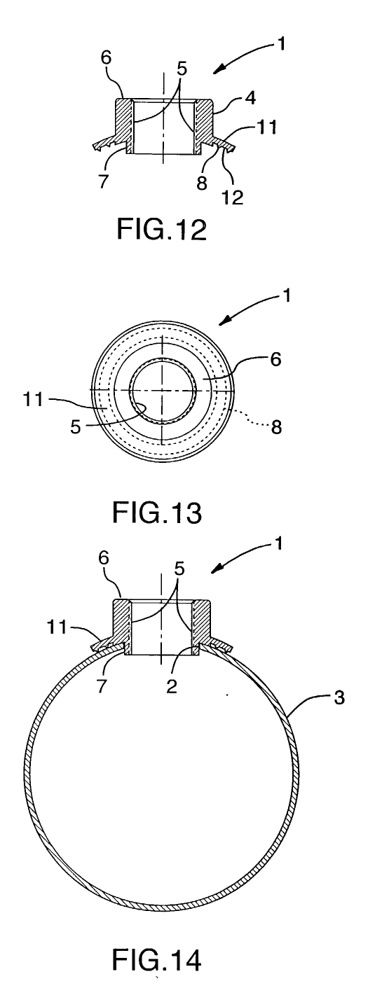

FIG. 12 to 14 show a boss 1 according to a fourth embodiment of the invention. The features which are the same as described earlier with regard to the first embodiment retain their reference numbers. The external surface 4 has a skirt 11 generally conforming to the profile of the pipe. The skirt has at least one pointed annular protrusion 8, for concentrating a weld spark during welding. The difference compared to the earlier described embodiments is that the protrusion(s) contact an outer surface of the pipe further removed from the area adjacent the hole 2.

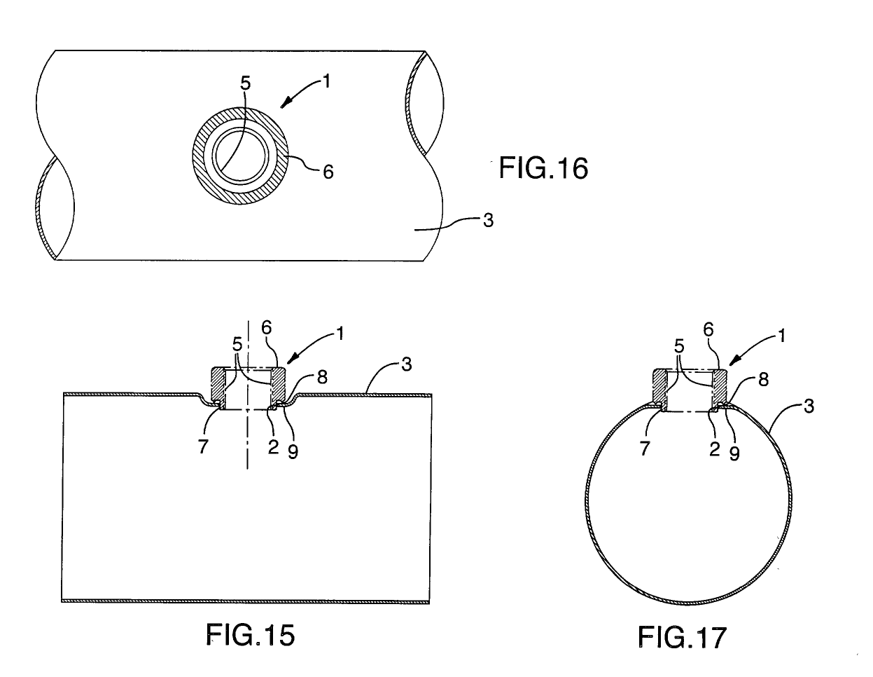

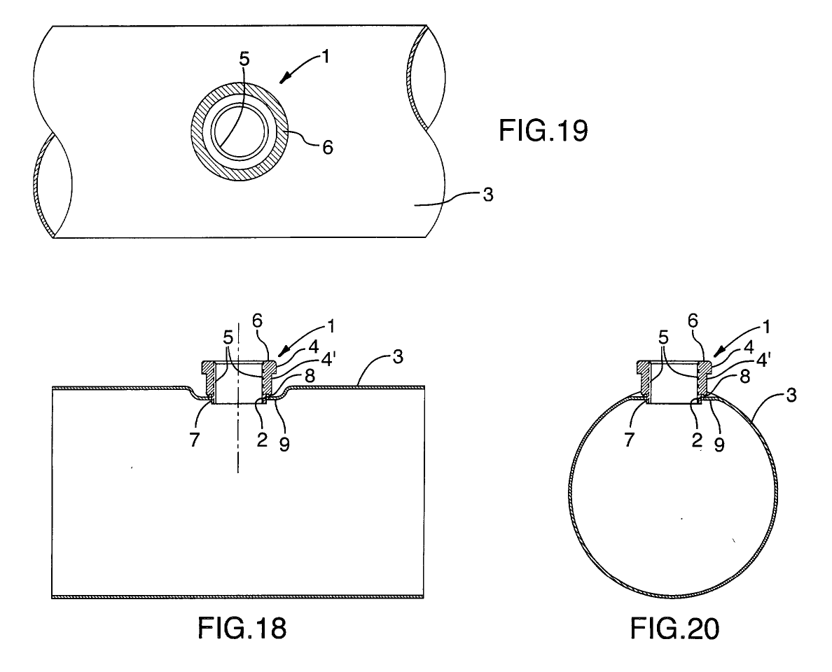

FIGS. 15 to 17 show a boss 1 according to the first embodiment of the invention inserted into the hole 2 which has been coined into the pipe. For example, a mandrel may be used to punch the hole from outside the pipe whilst a holed dolly is held inside the pipe, in a known way. The weld will thus occur along the pointed edge of the protrusion 8 all around the boss between the boss and the flat surface surrounding the hole. Similarly, FIGS. 18 to 20 show a boss 1 according to the third embodiment of the invention inserted into the hole 2 which has been coined into the pipe.

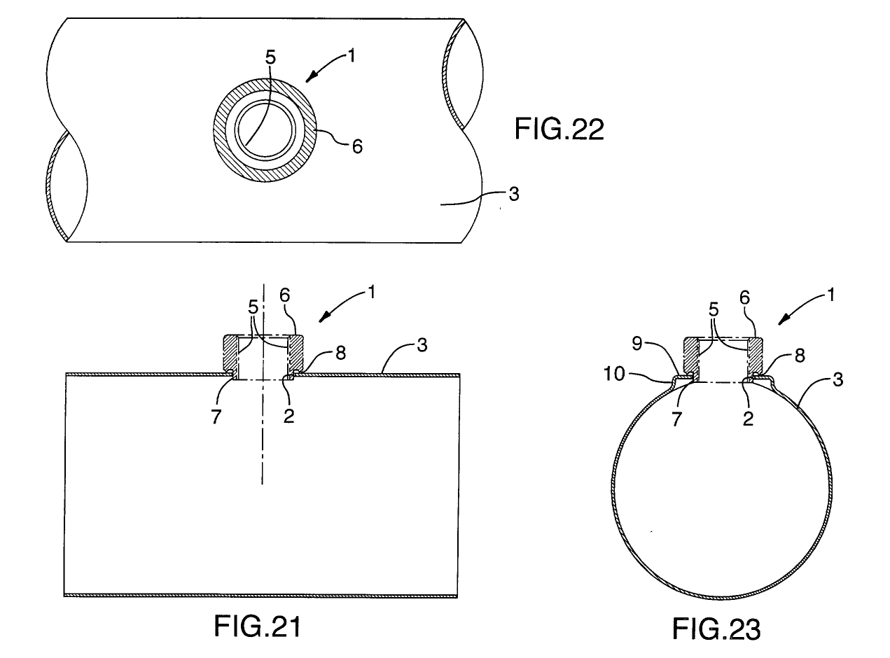

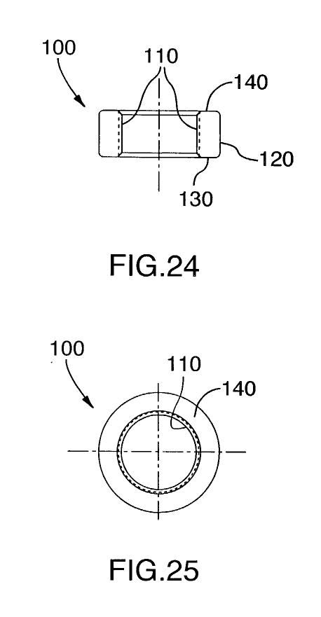

FIGS. 21 to 23 show a boss 1 according to the first embodiment of the invention inserted into the hole 2 which has been stamped in the pipe and then pulled out from the pipe. A raised portion 10 of the hole has thus been formed, having an annular substantially flat surface 9 adjacent the hole, which receives the weld as described above.

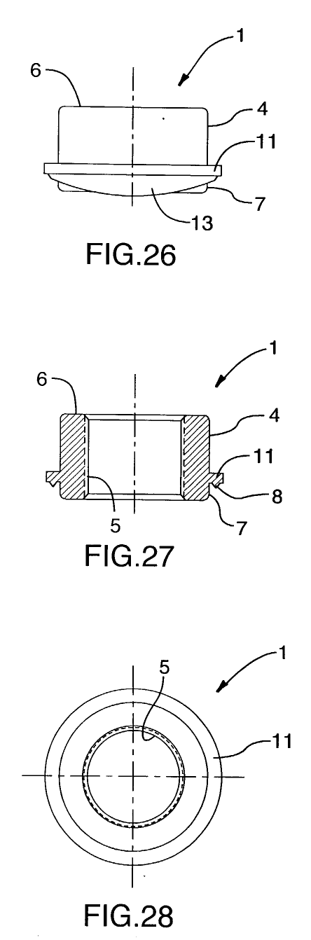

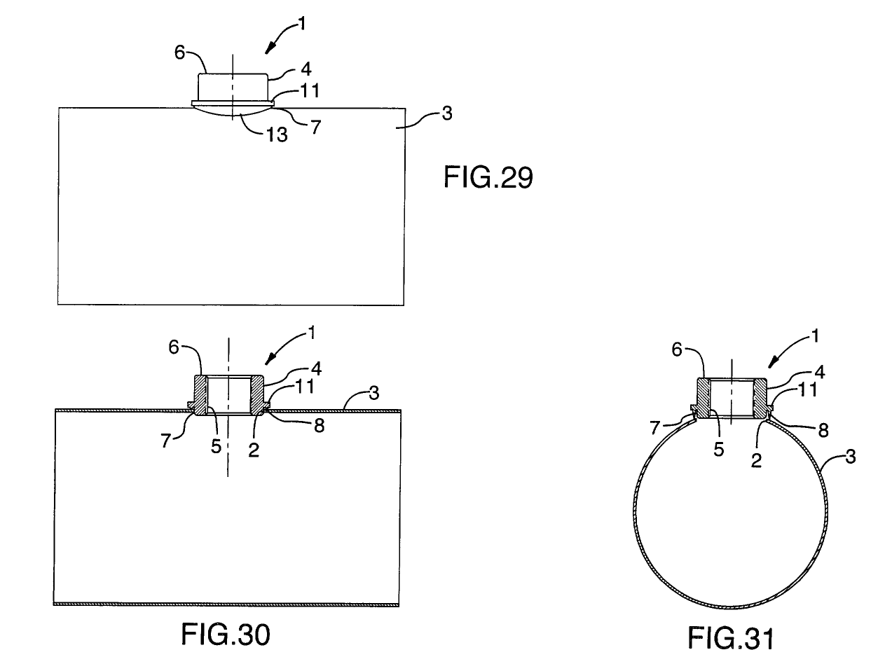

FIGS. 26 to 28 show a boss 1 according to a fifth embodiment of the invention. The features which are the same as described earlier with regard to the first embodiment retain their reference numbers. The external surface 4 has a skirt 11 generally conforming to the profile of the pipe. The skirt has at least one pointed annular protrusion 8, for concentrating a weld spark during welding. The skirt has a protruding annular saddle-shaped edge 13, which generally conforms to an outer surface of a pipe, when the boss is placed in a hole cut in the pipe (see FIGS. 29 to 31).

FIGS. 29 to 31 show a boss I according to the fifth embodiment of the invention inserted into the hole 2 which has been stamped in the pipe 3. The saddle-shaped edge 13, on which the at least one pointed annular protrusion 8 is arranged, closely follows the outer shape of the pipe adjacent the hole. A weld will then be made along the circumference of the skirt 11/protrusion 8 of the boss 1, providing a leak-tight joint between the boss and the pipe.

Several advantages are perceived with the invention compared to previously used art:

Faster cycle times.

The projections on the part or on the hole in the pipe (sharp annular edge) will force localization of the heat energy during the welding operation and keep flash from entering the central opening of the boss (often threaded).

Not necessary to use welding electrodes or brazing rods or similar.

The thickness of the boss material can be reduced.

A “hi-current/short-time” method is used to minimize the heat build-up during the actual welding and subsequent risk for part distortion.

Using the coining method to form the hole in the pipe, the same shape and size boss can be used for welding onto a variety of different pipe diameters.

A skirted boss will further enhance prevention of the weld spatter reaching un-wanted areas of the boss, for example the internal threads.

The method according to the invention reduces the weld thickness, amount of spatter and fumes generated, and the amount of welding material required to weld a boss.

It will be appreciated that the above description relates to the preferred embodiment by way of example only. Many variations on the invention will be obvious to those knowledgeable in the field, and such obvious variations are within the scope of the invention as described and claimed, whether or not expressly described. For example, the described method of welding a boss to a pipe can also be used to weld a flange to a pipe, by shaping the flange correspondingly to the boss surfaces, which mate with the pipe hole.

1. A boss for attaching to a manufactured hole in a pipe, said boss comprising a generally cylindrical hollow body, with an external surface and an internal surface, a first end and a second end, said second end having a smaller external diameter than a diameter of said external surface, said second end cooperating with said hole, wherein said second end has pointed protrusions, for concentrating a weld spark during welding.

2. The boss as recited in claim 1, wherein said external surface is stepped forming a larger diameter portion adjacent said first end and a smaller diameter portion adjacent said second end, said smaller diameter portion having a diameter larger than said diameter of said second end.

3. A boss for attaching to a manufactured hole in a pipe, said boss comprising a generally cylindrical hollow body, with an external surface and an internal surface, a first end and a second end, said second end having a smaller external diameter than a diameter of said external surface, said second end cooperating with said hole, wherein said second end has a bevelled portion cooperating with a pointed end of said hole, for concentrating a weld spark during welding.

4. A boss for attaching to a manufactured hole in a pipe, said boss comprising a generally cylindrical hollow body, with an external surface and an internal surface, a first end and a second end, said second end having a smaller external diameter than a diameter of said external surface, said second end cooperating with said hole, wherein said external surface has a skirt generally conforming to the profile of the pipe, said skirt having pointed protrusions, for concentrating a weld spark during welding.

5. A boss for attaching to a manufactured hole in a pipe, said boss comprising a generally cylindrical hollow body, with an external surface and an internal surface, a first end and a second end, said second end having a smaller external diameter than a diameter of said external surface, said second end cooperating with said hole, wherein said external surface has a skirt, said skirt having a protruding annular generally saddle-shaped edge generally conforming to the profile of the pipe, said saddle-shaped edge having pointed protrusions, for concentrating a weld spark during welding.
